(19) United States
(12) Patent Application Publication
(10) Pub. No.: US 2010/0002876 A1
(43) Pub. Date: Jan. 7, 2010

(54) ENCRYPTION APPARATUS, DECRYPTION APPARATUS, LICENSING APPARATUS AND CONTENT DATA GENERATION METHOD

(75) Inventors: Shuuichi Sugie, Tokyo (JP); Shinsaku Kiyomoto, Tokyo (JP); Tatsuo Shibata, Tokyo (JP); Keigo Majima, Tokyo (JP); Takeshi Kimura, Tokyo (JP); Shunji Sunasaki, Tokyo (JP); Kiyohiko Ishikawa, Tokyo (JP); Hideki Kokubun, Tokyo (JP); Koichi Ishikawa, Tokyo (JP); Masaru Fukushima, Yokohama-shi (JP); Takeshi Yamane, Yokohama-shi (JP); Ryo Goto, Yokohama-shi (JP)

Correspondence Address: MORGAN LEWIS & BOCKIUS LLP, 1111 PENNSYLVANIA AVENUE NW, WASHINGTON, DC, 20004, US

(73) Assignees: KYOCERA CORPORATION, KYOTO-SHI (JP); KDDI CORPORATION, TOKYO (JP); NIPPON HOSO KYOKAI, TOKYO (JP)

(21) Appl. No.: 12/301,022

(22) PCT Filed: May 16, 2007
(86) PCT No.: PCT/JP2007/060060

§ 371 Date: Jun. 10, 2009

(30) Foreign Application Priority Data
May 16, 2006 (JP) 2006-137002
May 16, 2006 (JP) 2006-137004

(51) Int. Cl. H04L 9/18; H04L 9/08

(52) U.S. Cl. 380/42; 380/279; 380/255

(57) ABSTRACT

In order to provide various service types to the users in a case of supplying the contents constituted from multiple resources via broadcast, the following apparatuses are provided. An encryption apparatus (100) encrypts the resources-to-be-encrypted of the contents, stores the encrypted resources in the packets and transmits the packets via broadcast. An encryption portion which encrypts each of contents constituted from multiple resources by applying a corresponding encryption key and generates and transmits packets that store encrypted data or non-encrypted data of the resources. A licensing apparatus (2) providing a license via communication network while the license includes both a license identifier which indicates a broadcast range in which the license is effective and the decryption key provided in correspondence with each of resources-to-be-encrypted. A decryption apparatus (300), by using the corresponding decryption key included in the license received via communications lines, decrypts the encrypted data of the packets received via broadcast.

### TECHNICAL FIELD

The present invention relates to an encryption apparatus, a decryption apparatus, a licensing apparatus and a content data generation method

Priority is claimed on Japanese Patent Applications No. 2006-137002, filed May 16, 2006, and No. 2006-137004, filed May 16, 2006, the content of which is incorporated herein by reference.

### BACKGROUND ART

For example, Patent Document 1 describes a conventional service providing system using broadcast signals and communication network. In the conventional technique described in Patent Document 1, when the contents are broadcasted by using broadcast signals, a broadcast decoder activation signal which activates a broadcast decoder installed inside a terminal of a receiving side is transmitted by communication network, hence, on the receiving side, the broadcast decoder is activated based on the received broadcast decoder activation signal, and the contents are received (watched and/or listened) via broadcast.

However, in the above-described conventional technique, in a case of providing the contents constituted from multiple resources (moving pictures, voice, data, and the like) by broadcasting, the broadcast decoder of the receiving side is activated by using only one broadcast decoder activating signal, and it is not possible to provide various service types to the users.

On the other hand, with regard to techniques of mobile terminals, in the recent years, the digital broadcast for the mobile terminal is put to practical use. With regard to an encryption method of programs of the digital broadcast for the mobile terminal, by 10 taking the performance of the mobile terminal into account, it is supposed that the stream cipher which is light is preferable rather than the block cipher which is generally used in a content distribution over the Internet. In the stream cipher, in order to achieve a normal decryption, synchronization of the stream cipher algorithm between an encryption apparatus and a decryption apparatus is essential.

However, if a transport packet which includes the stream cipher data is lost because of transmission errors and the like of the broadcast data in the digital broadcast, the stream cipher algorithm between the encryption apparatus and the decryption apparatus does not synchronize, and there are decryption errors.
[Patent Document 1] Japanese Patent Application, First Publication No. 2005-159457
[Patent Document 2] Japanese Patent No. 3030341
[Patent Document 3] Japanese Patent No. 3455748

### DISCLOSURE OF INVENTION

The present invention was conceived in order to solve the above-described problem and has an object to provide an encryption apparatus, a decryption apparatus and a licensing apparatus that can provide various service types to the users in a case of supplying the contents constituted from multiple resources by broadcasting

In addition, the present invention has another object to provide an encryption apparatus, a decryption apparatus and a content data generation method using the stream cipher that can strengthen the tolerance against loss of the transmission data due to transmission errors and the like.

In order to solve the above-described problem, for example, the present invention provides following aspects.

A first aspect of the present invention is an encryption apparatus used for providing contents constituted from a plurality of resources by broadcasting, preferably including: an encryption unit encrypting each of the resources-to-be-encrypted by applying a corresponding encryption key; a packet generation unit generating packets that store encrypted data or non-encrypted data of the resources; and a transmission unit transmitting the packets.

A second aspect of the present invention is a license issuing apparatus, via communication network, providing a license used for decrypting a plurality of resources which constitute contents transmitted by broadcasting and which are encrypted by using a corresponding encryption key, preferably including: a memory unit storing the license; and a license transmission unit transmitting the license stored in the memory unit wherein the license comprises a combination of a license identifier and a decryption keys the license identifier indicates a broadcast range in which the license is effective, and the decryption key is provided in correspondence with each of resources-to-be-encrypted

A third aspect of the present invention provides a decryption apparatus used for providing contents by broadcasting constituted from a plurality of resources while including encrypted resources by using corresponding encryption key if the resources are to be encrypted, preferably including: a broadcast receiving unit receiving packets via broadcast; a packet distribution unit distributing the received packets including encrypted data for each resources-to-be-encrypted; a license receiving unit receiving a license via communication network; and a decryption unit decrypting the encrypted data included in the packets distributed for each resources-to-be-encrypted, by using a corresponding decryption key included in the received license.

A fourth aspect of the present invention is the above-described decryption apparatus, preferably further including a license maintaining unit which stores the license.

A fifth aspect of the present invention is the above-described decryption apparatus, preferably further including a decryption control unit which, based on the license identifier, controls the decryption of broadcast for the range in which the license is effective.

A sixth aspect of the present invention is the above-described decryption apparatus, preferably further including a storage unit which stores the contents received via broadcast.

A seventh aspect of the present invention is the above-described decryption apparatus, preferably further including a licensing unit obtaining via communication network a license that is effective to the range of the broadcast which is currently being received.

An eighth aspect of the present invention is the above-described decryption apparatus, preferably further including: a display unit indicates contents on a screen that are currently being received or going to be received via broadcast; a designation unit accepting a designation of the contents which are indicated on the screen; and a licensing unit obtaining a license corresponding to the designated contents via the designation unit.

A ninth aspect of the present invention is the above-described decryption apparatus, preferably farther including: a display unit indicates contents on a screen that are currently received or going to be received via broadcast or that are stored in the storage unit; a designation unit accepting a designation of the contents which are indicated on the screen, and a licensing unit obtaining a license corresponding to the designated contents via the designation unit.

A tenth aspect of the present invention is the above-described decryption apparatus, wherein the display unit preferably indicates on the screen whether or not there is a license corresponding to the designated contents which are indicated on the screen.

In accordance with the above-described aspects of the present invention, it is possible to provide various service types to the users in a case of supplying the contents constituted from multiple resources by broadcasting.

In addition, in order to solve the above-described problem, for example, the present invention provides following aspects.

An eleventh aspect of the present invention is preferably an encryption apparatus including: an initialization packet generation unit generating an initialization packet which stores an initial value used in an initializing operation of a stream cipher algorithm and which is generated in an interval between initializing operations of the stream cipher algorithm; an encrypting unit conducting a stream cipher operation after the initialization operation of the stream cipher algorithm by using the initial value stored in the initialization packet; an encrypted packet generation unit generating an encrypted packet including data on which the stream cipher operation is conducted; and a transmission unit transmitting both the encrypted packet and the initialization packet.

A twelfth aspect of the present invention is the above-described encryption apparatus, wherein the initialization packet generation unit preferably applies an initialization interval corresponding to types of media of data which is going to be encrypted.

A thirteenth aspect of the present invention is the above-described encryption apparatus, wherein the encryption unit is preferably plural, and the initial value of each of a plurality of the encryption units is preferably stored in the initialization packet by the initialization packet generation unit.

A fourteenth aspect of the present invention is the above-described encryption apparatus, wherein the initialization packet and the encrypted packet are preferably transport packets and are preferably different types of packets.

A fifteenth aspect of the present invention is preferably a decryption apparatus including: a receiving unit receiving an initialization packet and an encrypted packet; and a decrypting unit, after conducting an initialization operation of stream decipher algorithm by using a given initial value stored in the initialization packet, conducting a stream decipher operation in order to obtain data on which a stream cipher operation is conducted from the encrypted packet.

A sixteenth aspect of the present invention is the above-described decryption apparatus wherein the decryption unit is preferably plural, and each of the decryption units uses the given initial value and preferably decrypts given data on which a stream cipher operation has been conducted.

A seventeenth aspect of the present invention is the above-described decryption apparatus preferably further including a counting unit which counts the encrypted packs that are lost, wherein the decryption portion preferably conducts an idle operation of the decipher operation for a time as much as a number of the lost encrypted packets.

A eighteenth aspect of the present invention is the above-described decryption apparatus preferably her including multiple counting units in correspondence with the decryption units counting the encrypted packets that are lost, wherein the decryption portion preferably conducts an idle operation of the decipher operation for a time as much as a number of the lost encrypted packets.

A nineteenth aspect of the present invention is the above-described decryption apparatus wherein the decryption unit preferably avoids conducting the idle operation if a number of the lost packets exceeds the countable range.

A twentieth aspect of the present invention is the above-described decryption apparatus wherein the initialization packet and the encrypted packet are preferably transport packets and are preferably different types of packets.

A twenty-first aspect of the present invention is preferably an encryption apparatus including: an initialization packet insertion unit inserting an initialization packet, which stores an initial value used in an initialization operation of a stream cipher algorithm, into a sequence of packets that store stream content data at a position of each of units of the stream content data; an encrypting unit conducting a stream cipher operation on the stream content data after an initialization operation of a stream cipher algorithm by using the initial value stored in the initialization packet; and a transmission unit transmitting both an encrypted packet storing the encrypted stream content data and the initialization packet.

A twenty-second aspect of the present invention is the above-described encryption apparatus wherein the initialization packet insertion unit preferably inserts the initialization packet at a position just before a packet which stores a reference video frame.

A twenty-third aspect of the present invention is the above-described encryption apparatus wherein the reference video frame is preferably an I-picture or an IDR-picture.

A twenty-fourth aspect of the present invention is the above-described encryption apparatus wherein the initialization packet insertion unit preferably inserts the initialization packet at a position just before a packet which stores a sound frame.

A twenty-fifth aspect of the present invention is the above-described encryption apparatus wherein the initialization packet insertion unit preferably inserts the initialization packet at a position just before a packet which stores an ADTS header

A twenty-sixth aspect of the present invention is the above-described encryption apparatus wherein the initialization packet insertion unit preferably inserts the initialization packet into a sequence of packets, which store data-broadcast content data, for every unit of data that are repeatedly broadcasted.

A twenty-seventh aspect of the present invention is a content data generation method which preferably includes the steps of: conducting an initialization operation of a stream cipher algorithm by using an initial value stored in an initialization packet; conducting a stream cipher operation of stream content data; and inserting the initialization packet, which stores an initial value used the an initialization operation of the stream cipher algorithm, into a sequence of packets that store the stream content data for each processing units of the stream content data.

A twenty-eighth aspect of the present invention is the above-described content data generation method wherein the initialization packet is preferably inserted at a position just before a packet which stores a reference video frame

A twenty-eighth aspect of the present invention is the above-described content data generation method wherein the reference video frame is preferably an I-picture or an IDR-picture.

A thirtieth aspect of the present invention is the above-described content data generation method wherein the initialization packet is preferably inserted at a position just before a packet which stores a sound frame

A thirty-first aspect of the present invention is the above-described content data generation method wherein the initialization packet is preferably inserted at a position just before a packet which stores an ADTS header.

A thirty-second aspect of the present invention is the above-described content data generation method wherein the initialization packet is preferably inserted into a sequence of packets, which store data-broadcast content data, for every unit of data that are repeatedly broadcasted.

In accordance with the above-described aspect of the present invention, in the stream cipher, it is possible to strengthen the tolerance against loss of the transmission data due to transmission errors and the like.

In addition, in order to solve the above-described problem, for example, the present invention provides following aspects.

A thirty-third aspect of the present invention is the above-described encryption apparatus, wherein the encryption unit, regarding contents constituted from multiple resources, preferably encrypts each of the resources-to-be-encrypted by applying a corresponding encryption key, the encrypted packet generation unit preferably generates packets that store encrypted data or non-encrypted data of the resources, and the transmission unit preferably transmits the packet generated by the encrypted packet generation unit.

A thirty-fourth aspect of the present invention is the above-described encryption apparatus, preferably further including an initialization packet generation unit generating an initialization packet which stores an initial value used in an initializing operation of a stream cipher algorithm and which is generated in an interval between initializing operations of the stream cipher algorithm, wherein the encrypting unit preferably conducts a stream cipher operation after the initialization operation of the stream cipher algorithm by using the initial value stored in the initialization packet.

A thirty-fifth aspect of the present invention is the above-described encryption apparatus, preferably wherein the initialization packet generation unit preferably applies an initialization interval corresponding to types of media of data which is going to be encrypted.

A thirty-sixth aspect of the present invention is the above-described encryption apparatus, preferably wherein the encryption unit is preferably plural, and the initial value of each of a plurality of the encoding units is preferably stored in the initialization packet by the initialization packet generation unit.

A thirty-seventh aspect of the present invention is the above-described encryption apparatus, preferably wherein the initialization packet and the encrypted packet are preferably transport packets and are preferably different types of packets.

A thirty-eighth aspect of the present invention is preferably a broadcast system providing contents by broadcasting, including: an encryption unit, encrypting each of the plurality of contents constituted from a plurality of resources by applying a corresponding encryption key and generating and transmitting packets that store encrypted data or non-encrypted data of the resources; a license transmission unit transmitting via the communications network a license that is used for decrypting the encrypted data; and a decryption unit, after receiving the packets including encrypted data for each resource-to-be-encrypted, decrypting the encrypted data by using the license received via the communications network, wherein the license comprises a combination of a license identifier and a decryption key, the license identifier indicates a broadcast range in which the license is effective, the decryption key is provided in correspondence with each of resources-to-be-encrypted, the decryption unit, by using the received corresponding decryption key included in the license, decrypts the encrypted data of the packet for each resource-to-be-encrypted.

### BRIEF DESCRIPTION OF THE DRAWINGS

FIG. 1 is a block diagram showing a constitution of a broadcast system of one embodiment of the present invention.

FIG. 2 is a block diagram showing a constitution of an encryption apparatus 100 shown in FIG. 1.

FIG. 3 is a drawing showing an example of a constitution of a transport packet (TS packet) of one embodiment of the present invention.

FIG. 4 is a drawing showing an example of a constitution of a license 200 provided by a licensing apparatus 2 shown in FIG. 1.

FIG. 5 is a block diagram showing a constitution of a decryption apparatus 300 shown in FIG. 1.

FIG. 6 is a block diagram showing an example of a constitution of a screen 30 on a terminal apparatus 3 shown in FIG. 1.

FIG. 7 shows a data structure of a broadcast signal explaining an example of a structure of an identifier which is a combination of an encryption process and a decryption process in one embodiment of the present invention.

FIG. 8 shows a data structure of a descriptor explaining an example of a structure of an identifier which is a combination of an encryption process and a decryption process in one embodiment of the present invention.

FIG. 9 is a block diagram showing a constitution of a decryption apparatus of another embodiment of the present invention.

FIG. 10 is a block diagram showing a constitution of an encryption apparatus 1100 of the stream cipher of a second embodiment of the present invention.

FIG. 11 is a drawing showing an example of a constitution of an initialization packet (IV packet) of a second embodiment.

FIG. 12 is a block diagram showing a constitution of a decryption apparatus 1200 of the stream cipher of a second embodiment of the present invention.

FIG. 13 is a block diagram showing a constitution of a decryption apparatus 1220 of the stream cipher of a third embodiment of the present invention.

FIG. 14 is a block diagram showing a constitution of a decryption apparatus 1240 of the stream cipher of a fourth embodiment of the present invention.

FIG. 15 is a block diagram showing a constitution of an encryption apparatus 1120 of the stream cipher of a fifth embodiment of the present invention.

FIG. 16 is a drawing which explains an insertion operation of an IV packet of a fifth embodiment of the present invention.

FIG. 17 is a drawing which explains an insertion operation of an IV packet of a fifth embodiment of the present invention.

### DESCRIPTION OF THE REFERENCE SYMBOLS

1 . . . broadcasting station
2 . . . licensing apparatus
3 . . . terminal apparatus
4 . . . communication network
30 . . . screen
31 . . . image screen
32 . . . data-broadcast screen
100 . . . encryption apparatus
110 . . . encryption portion
111 . . . encryption process
120 . . . packet generation portion
130 . . . transmission portion
200 . . . license
300 . . . decryption apparatus
310 . . . broadcast receiving portion
320 . . . packet distribution portion
330 . . . decryption portion
331 . . . decryption process
340 . . . license receiving portion
350 . . . license storing portion
360 . . . license management portion
370 . . . licensing control portion
600 . . . storage portion
1100 . . . encryption portion
1120 . . . encryption portion
1101 . . . header conversion portion
1102 . . . IV packet insertion portion
1103 . . . encryption portion
1104 . . . transmission portion
1121 . . . data analysis portion
1200 . . . decryption apparatus
1220 . . . decryption apparatus
1240 . . . decryption apparatus
1201 . . . receiving portion
1202 . . . packet distribution portion
1203 . . . IV packet reading portion
1204 . . . decryption portion
1221 . . . counter check portion
1241 . . . counter check and decryption portion
1102a . . . IV packet insertion portion
1130 . . . I picture
1140 . . . IV packet
1150 . . . ADTS header
1300 . . . playback device
1301 . . . image playback portion
1302 . . . sound playback portion
1303 . . . data-broadcast display portion

### BEST MODE FOR CARRYING OUT THE INVENTION

### First Embodiment

Hereinafter, in reference to the drawings, one embodiment of the present invention is explained.

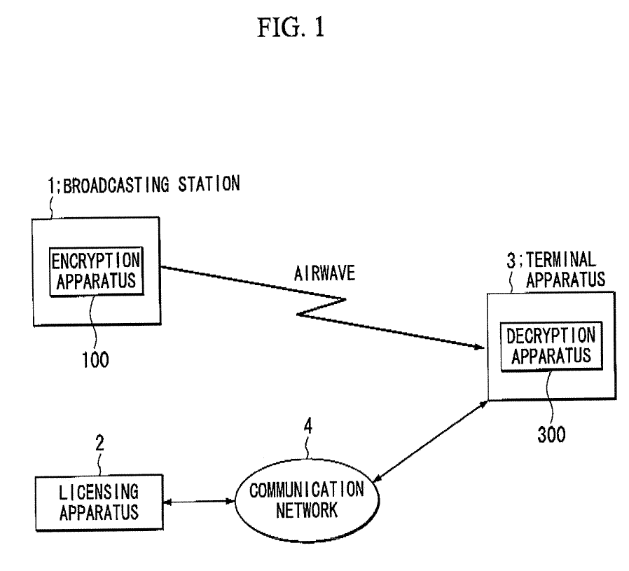

FIG. 1 is a block diagram showing a constitution of a broadcast system of one embodiment of the present invention. In FIG. 1, a broadcasting station 1 has an encryption apparatus 100. The encryption apparatus 100 encrypts the contents provided by broadcasting. A licensing apparatus 2 provides a license received via a communication network that is necessary for decrypting the encrypted contents broadcasted from the broadcasting station 1. A terminal apparatus 3 has decryption apparatus 300. By using the license issued from the licensing apparatus 2, the decryption apparatus 300 decrypts the encrypted contents broadcasted from the broadcasting station 1.

The licensing apparatus 2 and the terminal apparatus 3 respectively have a communication function for connecting a communication network 4 which is for example, the Internet. The terminal apparatus 3 can be a fixed-line terminal and can be a mobile terminal. If the terminal apparatus 3 is a mobile terminal, the mobile terminal connects to the Internet, and the like via a mobile communication network. In addition, the terminal apparatus 3 has a receiving function of the broadcasted waves.

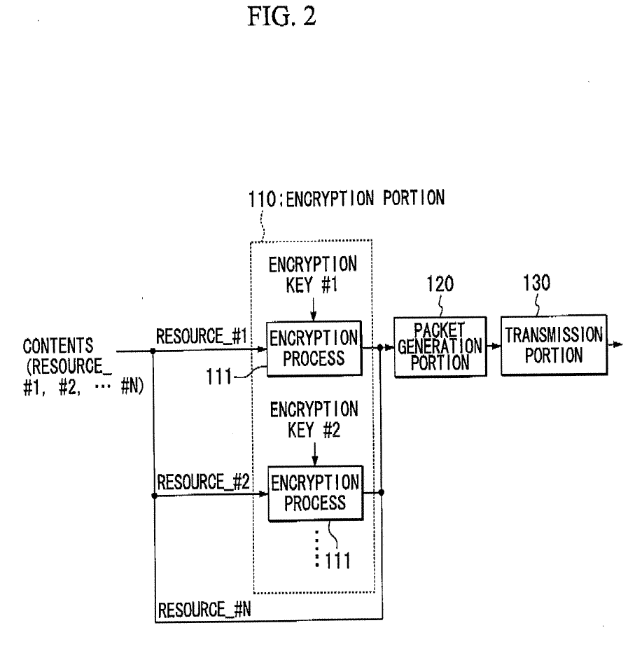

FIG. 2 is a block diagram showing a constitution of an encryption apparatus 100 shown in FIG. 1. In FIG. 2, the contents are constituted from multiple resources. Types of the resources are, for example, video, voice/sounds and data. It is possible that all of the resources included in the contents are encrypted, and in addition, it is possible that the contents include a portion of resources that are not encrypted. In an example of FIG. 2, the contents are constituted from N resources that are a from resource_#1 to a resource_#N, and the resource_#1 and resource_#2 are going to be encrypted, but the resource_#N is not going to be encrypted. For example, in a concrete case of the contents constituted from a video resource, a sound/voice resource and a data resource, it is possible that both the video resource and the sound/voice resource are encrypted while the data resource is not encrypted.

The encryption apparatus 100 shown in FIG. 2 includes an encryption portion 110, a packet generation portion 120 and a transmission portion 130. It is possible that the encryption portion 110 include multiple encryption processes 111. Each of the multiple encryption processes 111, by using a corresponding encryption key, encrypts a corresponding resource which is going to be encrypted. In the example shown in FIG. 2, the resource_#1 and resource_#2 which are going to be encrypted are respectively encrypted by the corresponding encryption processes 111 by using encryption keys #1 and #2. The encrypted data of each of the resources is input by the packet generation portion 120. It should be noted that the resource_#N which is not going to be encrypted (non encrypted data) directly is input by the packet generation portion 120.

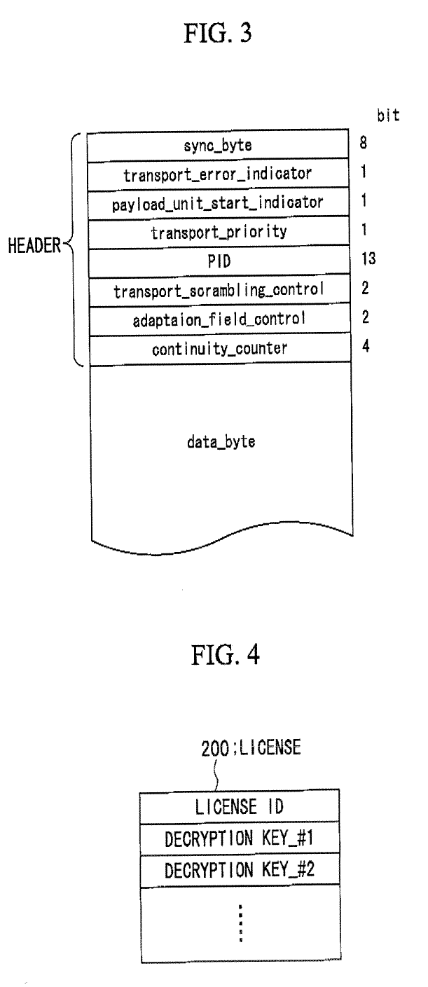

The packet generation portion 120 generates transport packets (TS packet) which store each of the encrypted data and non-encrypted data of the resources. FIG. 3 shows an example of a constitution of the TS packet. The TS packet shown in FIG. 3 conforms to ISO/IEC 13818-1 (standard of MPEG-2 system). In FIG. 3, the data_byte field stores encrypted data if the resource is to be encrypted, and the data_byte field stores non-encrypted data if the resource is not to be encrypted. In addition, the transport_scrambling_control field stores a value which indicates the resource is whether or not to be encrypted or not to be encrypted. “01”, “10” and “11” are values of the transport_scrambling_control field indicating that the field is to be encrypted. “00” is a value of the transport_scrambling_control field indicating that the field is not to be encrypted.

In addition, in a case in which the resource is to be encrypted, “01”, “10” and “11” are used for determining the encryption process 111 that has encrypted the resource. Therefore, based on “01”, “10” and “11” of the transport_scrambling_control field, it is possible to determine one process among three encryption processes 111. Here, the encryption process corresponds to the decryption process of the decryption apparatus, and the decryption process of the decryption apparatus can be determined based on “01”, “10” and “11” of the transport_scrambling_control field. It should be noted that, by using the transport_scrambling_control field, it is possible to provide three combinations between the encryption processes and decryption processes, and an extension that is applied to larger combinations is explained below.

The transmission portion 130 transmits the TS packet received from the packet generation portion 120

FIG. 4 is a drawing which shows an example of a constitution of a license 200 provided by the licensing apparatus 2 shown in FIG. 1. In FIG. 4, the license 200 is constituted from combinations of a license identifier (license ID) and a decryption key. The license ID indicates a broadcast range in which the license is effective. The broadcast range is regulated based on, for example, a broadcast time, a broadcast channel, contents and the resource. There are concrete examples of the broadcast range such as a specific broadcast channel at a specific broadcast time, specific contents of a specific broadcast channel and one or multiple specific resources of specific contents.

With regard to the license 200, corresponding to each of the resources-to-be-encrypted, the decryption key in combination with the license ID is provided. For example, in an example of FIG. 2, the resource_#1 and resource_#2 are respectively encrypted by using encryption key_#1 and encryption key_#2. In this case, corresponding to the resources_#1 and the resource_#2 that are to be encrypted the decryption key_#1 and decryption key_#2 are respectively provided.

The licensing apparatus 2 has a memory means for storing the license 200. For example, a database is constituted for storing the license 200. In addition, the licensing apparatus 2 has a transmission means for transmitting the license 200 stored inside the memory means. The transmission means transmits the license 200 to the terminal apparatus 3 via the communication network 4.

It should be noted that it is possible to constitute the licensing apparatus 2 from the dedicated hardware, and in addition, it is possible to constitute the licensing apparatus 2 from a computer system such as a server computer and to realize functions of the licensing apparatus 2 by executing computer programs that conducts functions of the licensing apparatus 2.

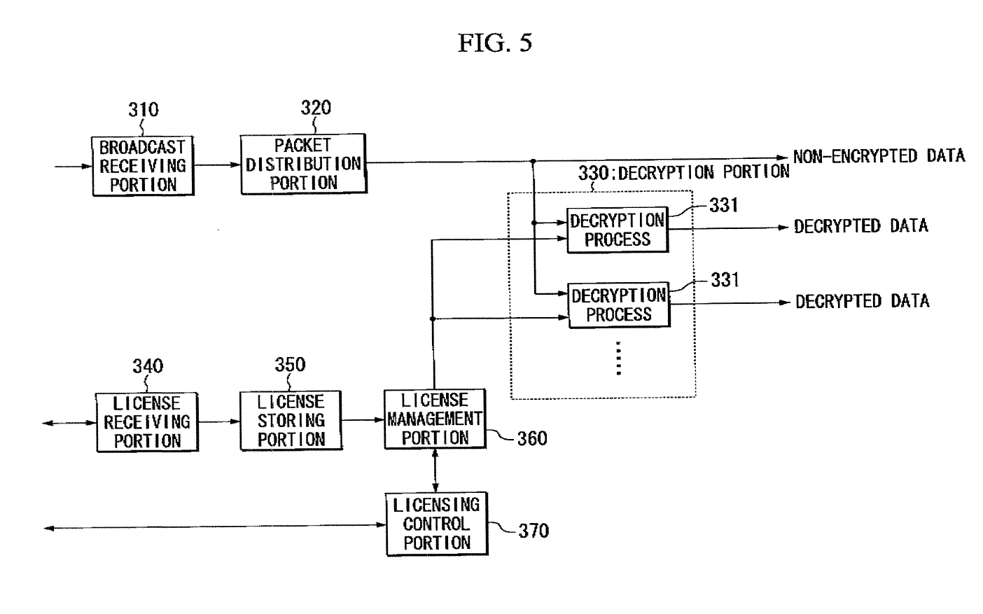

FIG. 5 is a block diagram showing a constitution of a decryption apparatus 300 shown in FIG. 1. In FIG. 5, a broadcast receiving portion 310 receives the TS packet via the broadcast signals. Here, the broadcast receiving portion 310 receives the channel specified by the user's operation.

A packet distribution portion 320 distributes the TS packets among the received TS packets that contain encrypted data into the resources that are going to be encrypted. For example, in a case of the TS packets shown in FIG. 3, the TS packets which have the transport_scrambling_control fields in which a value of “01”, “10” or “11” stores the encrypted data hat is obtained by encrypting the resource-to-be-encrypted, and the decryption process that decrypts the encrypted data is identified based on “01”, “10” or “11” of the transport_scrambling_control field.

It is possible for a decryption portion 330 to provide multiple decryption processes 331. An identifier is assigned to each of the multiple decryption processes 331 in order to respectively identify the decryption processes 331. Based on the identifier, each of the multiple decryption processes 331 inputs the encrypted data of the resource-to-be-encrypted that is distributed by the packet distribution portion 320. Each of the multiple decryption processes 331 decrypts the encrypted data by using the decryption key which is provided by a license management portion 360. Each of the decrypted data is played back by the terminal apparatus 3. It should be noted that the non-encrypted data stored in the TS packet of the resource which is not to be encrypted is played back without conducting any special operations.

The license receiving portion 340 receives the license 200 from the licensing apparatus 2 via the communication network 4. After making a contract for issuing the license 200 that is effective with regard to a desired broadcast range, for example, via a license server on the Internet, the user can receive the license 200 by using the terminal apparatus 3. It should be noted that the license 200 can be paid or free.

A license storing portion 350 stores the license 200. By using the license storing portion 350, it is possible to receive and store the multiple licenses 200 beforehand, hence it is possible to obtain the license 200 without being disturbed every time playing back the contents.

The license management portion 360 controls a decryption operation by the decryption portion 330 based on the license 200. Based on the license ID included in the license 200, the license management portion 360 determines the broadcast range in which the license 200 is effective. For example, by comparing the license ID to the identification information included in the broadcasted signals that is not to be encrypted, it is possible to determine the broadcast range in which the license ID is effective.

It should be noted that the terminal apparatus 3 can be various types of apparatuses, hence it is not necessary for the decryption apparatus 300 to provide all types of the decryption processes 331 corresponding to all types of the licenses 200, and it is possible to for the decryption apparatus 300 to provide specific types of the decryption processes 331 that correspond to available services.

The license management portion 360 reads the licenses 200 which are effective to the broadcast range that is used in a currently conducting receiving operation from the license storing portion 350, and passes a decryption key included in the read license 200 to the corresponding decryption process 331. In accordance with such operations, the encrypted data of the resource-to-be-encrypted included in the broadcast range is automatically decrypted.

A licensing control portion 370 obtains the license 200 via the communication network 4. For example, the licensing control portion 370 accesses the license server on the Internet and has a negotiation or contract to obtain the license 200. It should be noted that it is possible to provide a function of the license server at the licensing apparatus 2. A license receiving portion 340 receives the license 200 which can be issued in accordance with the contract. An operation of obtaining the license 200 is explained below by showing two examples (Cases 1 and 2).

### (Case 1)

If there is no license 200 inside the license storing portion 350 that is effective with regard to the currently receiving broadcast band, the license management portion 360 outputs a command to the licensing portion 370 in order to obtain the license 200 which is effective with regard to the currently receiving broadcast band. In accordance with the command, the licensing control portion 370 tries to obtain the license 200 which is effective with regard to the currently receiving broadcast band. In accordance with such an operation, it is possible to automatically obtain the license 200.

### (Case 2)

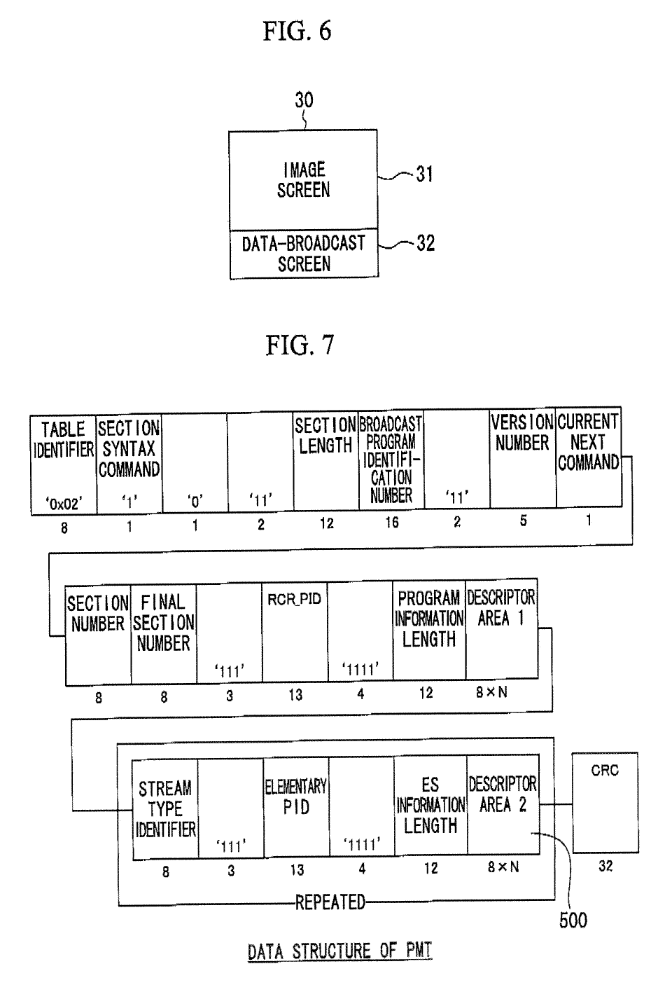

A display means is provided which shows the contents on the screen of the terminal apparatus 3 that are currently receiving or that is going to be received via broadcast. For example, on the screen 30 of the terminal apparatus 3 shown in FIG. 6 as an example, if the contents include both the video resource and the data resource, the video resource is shown on the image screen 31, and the data resource is shown on the data-broadcast screen 32. Here, for example, it is possible to show a mark on a lower portion of the image screen 31 that corresponds to the contents which is currently receiving or is going to be received in order to clearly indicate the contents. It should be noted that it is possible to distinguish whether the content is currently being received or is going to be received via broadcast in accordance with the contents information included in the broadcast signal which is not going to be encrypted, for example, the broadcast program information and the contents identifiers which are multiplexed on the broadcast signals.

In addition, by using he display means, it is possible to clearly show whether or not there is the license 200 corresponding to the contents shown on the screen of the terminal apparatus 3. For example, by showing a mark that indicates whether or not there is the license 200 at a lower portion inside the image screen 31 shown in FIG. 6, it is possible to clearly show whether or not there is the license 200 corresponding to the contents. It is possible to distinguish whether or not there is the license 200 by searching the license storing potion 350.

In addition, a designation means for designating the contents shown on the screen of the terminal apparatus 3 is provided. For example, it is possible to designate the contents by selecting the mark shown on the screen by using the operation key of the terminal apparatus 3.

The licensing control portion 370 tries to get the license 200 corresponding to the designated contents. Therefore, the user can watch/listen to the desired contents by getting the license 200 whenever he wants to.

As described above, in this embodiment, when providing the contents constituted from multiple resources (video, sound, data, and the like) via broadcast, the broadcast station can determine a setting of encryption and/or non-encryption with regard to each of the resources. Therefore, it is possible to provide a service which is selective with regard to each of the resources, and it is possible to provide various service types to the users.

In addition, it is possible to flexibly set a constitution of a decryption key included in the license, hence, it is possible to achieve various types of listening and watching styles of the contents. For example, in a case of the movie contents constituted from one movie resource and two sound resources (for example, Japanese sound and English sound), a license is provided which includes a decryption key applied to the movie resource and one of the sound resources (for example, Japanese sound), and another license is provided which includes a decryption key applied to the movie resource and another sound resource (for example, English sound). In accordance with such an example, by providing licenses applied to various patterns, it is possible to provide various types of listening and watching styles to the users.

It should be rioted that the encryption apparatus 100 and the decryption apparatus 300 of this embodiment can be constituted from a dedicated hardware and can be constituted from a memory, a CPU (central processing unit), and the like in order to achieve the functions by executing computer programs that realize the functions of these apparatuses.

Next, a solution for increasing combinations of the encryption process and the decryption process (hereinafter, “process combination”) is explained.

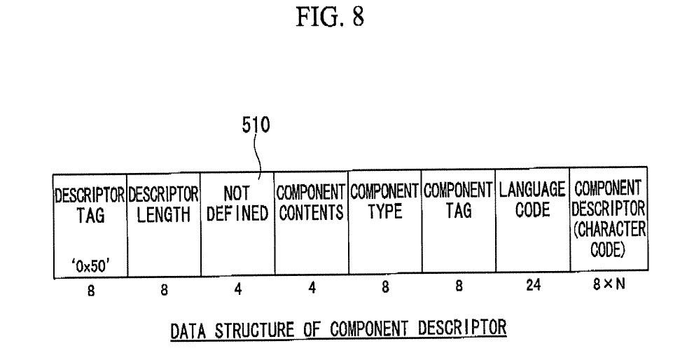

By applying a method in which the process combination is identified based on values of the transport_scrambling_control field included in the header of the TS packet shown in FIG. 3, it is possible to provide three process combinations at most. There are solutions for increasing process combinations, for example, by using both the data of PMT shown in FIG. 7 and a component descriptor shown in FIG. 8. The data constitutions shown in FIGS. 7 and 8 are respectively regulated in a standard “STD-B10” of ARIB (Association of Radio Industries and Businesses)

In a descriptor area 2_500 included in the data of PMT shown in FIG. 7, it is possible to store the component descriptor shown in FIG. 8. In addition, the identifier is stored in an undefined area 510 included in the component descriptor. The area 510 is a four-bit area, hence, it is possible to provide 16 identifiers at most, and even when one of 16 identifiers is determined as an identifier which indicates non-encryption, it is possible to identify fifteen process combinations by using 15 remained identifiers at most.

It should be noted that the component descriptor is an existing descriptor. It is possible to define a new descriptor. In such a case, it is possible to provide the identifiers as many as desired, and it is possible to further increase the process combinations.

As described above, the first embodiment of the present invention is explained in reference to the drawings in detail, but this embodiment is not a limitation of a concrete constitution, and the present invention includes such as modifications that are not out of the concept of the present invention.

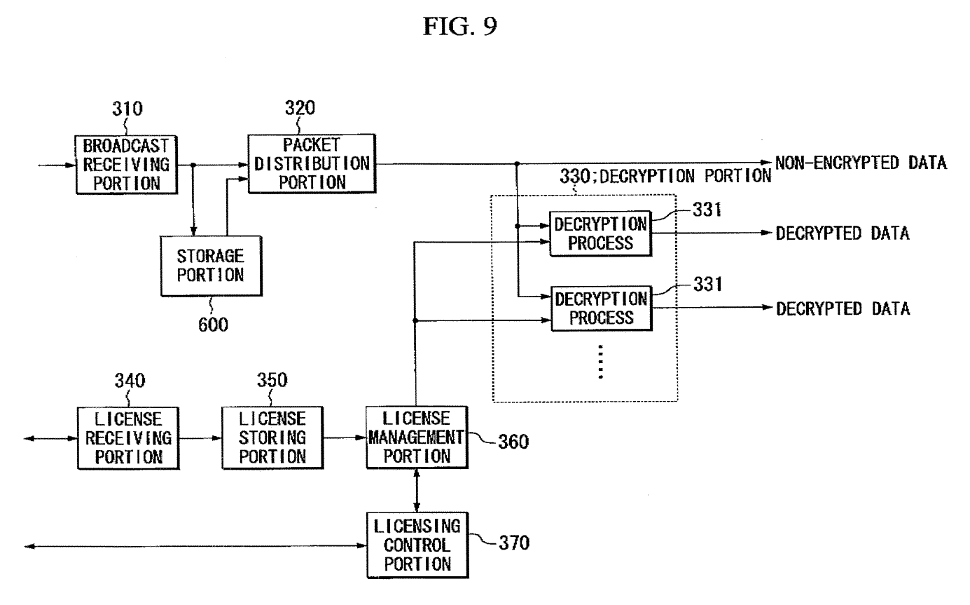

For example, it is possible to provide a storing means at the decryption apparatus in order to store the contents received via broadcast. FIG. 9 shows an example of a constitution of such a decryption apparatus. In FIG. 9, the decryption apparatus 300 of FIG. 5 further provides a storage portion 600. In FIG. 9, the storage portion 600 stores the TS packets received by the broadcast receiving portion 310. The packet distribution portion 320 reads the TS packets stored in the storage portion 600 and distributes the TS packets containing encrypted data into the resources that are going to be encrypted. Therefore, if the user cannot listen to or watch the currently broadcasted contents real-time, the user can decrypt, playback and listen to or watch the received and stored contents at a desired time.

In addition, in the decryption apparatus shown in FIG. 9, it is possible to provide the display means and the designation means as described in the case 2 above in order to obtain the license 200 corresponding to the contents that is designated by the user. In such a case, it is possible to control the display means so as to indicate the currently receiving contents via broadcast, the contents that are going to be received and/or the stored contents in the storing portion 600 on the display screen.

It should be noted that it is possible to apply the present invention to various types of broadcasting systems. For example, it is possible to apply to a digital broadcast system dedicated to mobile terminals. In such a case, when the contents constituted from multiple resources are provided via the digital broadcast, it is possible to provide various service styles that are appropriate for characteristics of the mobile terminals.

In addition, it is possible to apply the stream cipher or the block cipher to the encryption method of this embodiment.

### Second Embodiment

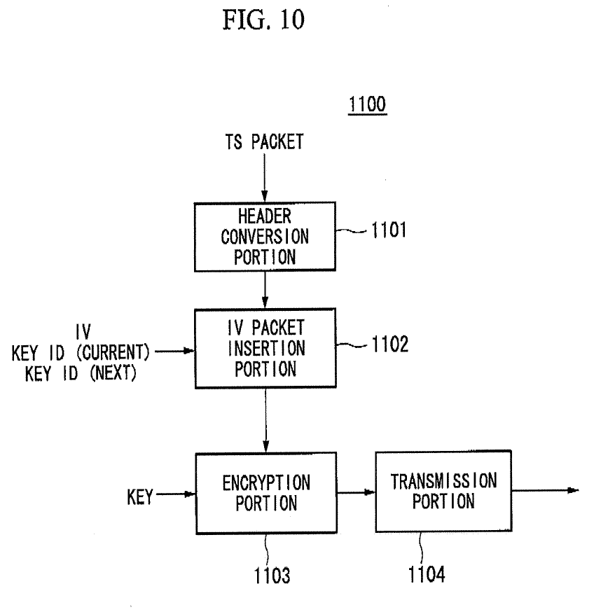

FIG. 10 is a block diagram showing a constitution of an encryption apparatus 1100 of the stream cipher of a second embodiment of the present invention.

In FIG. 10, a header conversion portion 1101 conducts a header conversion operation of a transport packet (TS packet). The TS packet is compliant to ISO/IEC 13818-1 MPEG-2 system standard). The header conversion portion 1101 overwrites the transport_scrambling_control field included in a header of the TS packet. “01”, “10” and “11” are values of the transport_scrambling_control field indicating that the field is to be encrypted. “00” is a value of the transport_scrambling_control field indicating that the field is not to be encrypted.

In an interval between initializing operations of the stream cipher algorithm, an IV packet insertion portion 1102 generates an IV packet which stores an initial value applied to the initializing operation in the stream cipher algorithm. In addition, the IV packet insertion portion 1102 stores a key ID in the IV packet. There are two types of key IDs that are “Current” and “Next”. The key ID “Current” is a currently used key identifier. The key ID “Next” is a key identifier which is used next time. The IV packet insertion portion 1102 inserts the IV packet which is generated by the IV packet insertion portion 1102 into an array of the TS packets output by the header conversion portion 1101.

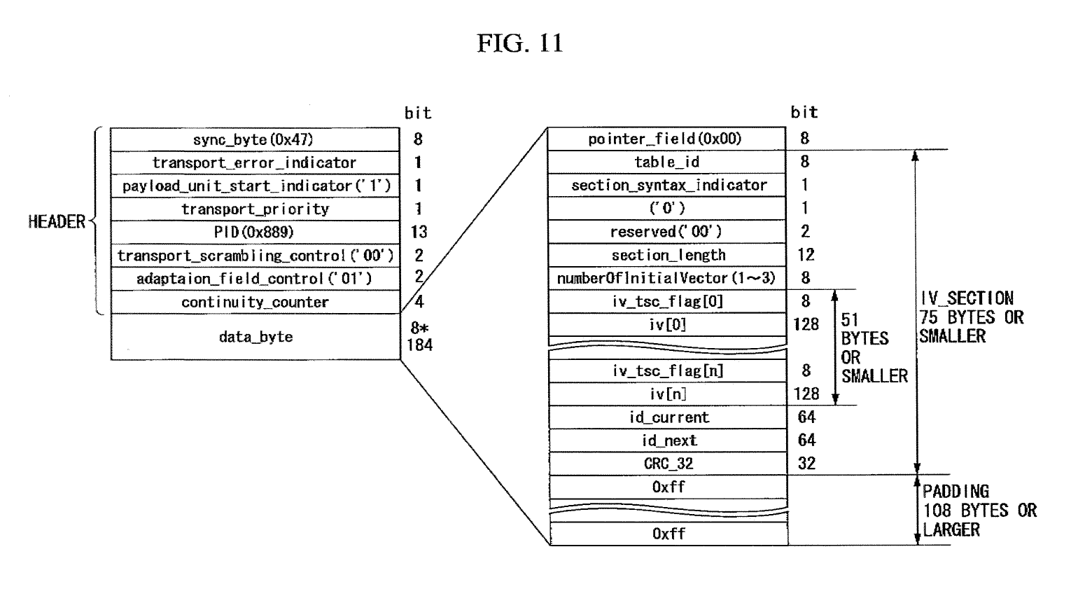

FIG. 11 shows an example of a constitution of the IV packet of this embodiment. In this embodiment, the IV packet is constituted as a type of the TS packets. In FIG. 11, in PID field of the header a value ‘0x889” (hexadecimal) is stored which indicates the IV packet. In addition, the transport_scrambling_control field stores “00”. That is, the IV packet is not encrypted. In addition, in this example, the adaptation_field_control field is fixed to “01”, and the adaptation_field does not exist.

In addition, in FIG. 11, the data_byte field includes IV (iv field) and the key IDs of both “Current” (id_current field) and “Next” (id_next field). It should be noted that it is possible to store multiple IV (iv[n]: n is an integer larger than or equals to 0). When the multiple IV are stored, a combination of iv_tsc_flag[n] and iv[n] is created. Each of iv[n] is used in an initializing operation of the stream cipher algorithm in a corresponding stream cipher operation.

In addition, it is possible to apply a different initializing interval to each of iv[n]. In such a case, iv [n] is stored in the IV packet only if it is a time for initializing. The initializing interval corresponding to each of iv [n] relates to the corresponding stream cipher operation. For example, the initializing interval is used that relates to types of media of the data that is going to be encrypted. There are various types of media such as sound/voice, video and data.

In addition, in an example shown in FIG. 11, an unused area included in the data_byte field is filled with ‘0xff’ (hexadecimal). In addition, in the data_byte field, “Cyclic Redundancy Check:CRC” (CRC_{—}32) for error detection is stored. It should be noted that if an error is detected by CRC check, the IV packet including the error is discarded at a receiving side of the IV packet.

The encryption portion 1103 conducts a stream cipher operation on a sequence of the TS packets to which the IV packets are inserted. The TS packets are encrypted if the transport_scrambling_control field is “01”, “10” or “11”. It should be noted that the header of the TS packet is not encrypted. In addition, the IV packet is not encrypted because the transport_scrambling_control field is “00”.

In this stream cipher operation, the encryption portion 1103 reads the IV of the IV packet if the IV packet (PID field is “0x889” (hexadecimal)) is detected in the sequence of the TS packets. After this, by using the read IV, an initializing operation of the stream algorithm is conducted. In other words, after conducting the initializing operation of the stream cipher algorithm in reference to a position of the IV packet included in a sequence of the TS packets, the stream cipher operation is conducted on the TS packet following the IV packet if the TS packet is going to be encrypted.

In the initializing operation of the stream cipher algorithm, the key ID “Current” (id_current) and “Next” (id_next) are read, and a key applied to a stream cipher operation is prepared.

In addition, it is possible for the encryption portion 1103 to include multiple stream cipher operations [n]. By using the corresponding IV (iv[n]), each of the stream cipher operations [n] conducts an initializing operation of the stream cipher algorithm. It should be noted that each of the stream cipher operations [n] determines whether or not the TS packet should be encrypted based on a value of the PID field.

The encryption portion 1103 outputs the sequence of the TS packets including the IV packet and the encrypted TS packet to a transmission portion 1104 in a receiving order from the IV packet insertion portion 1102.

The transmission portion 1104 transmits the sequence of the TS packets received from the encryption portion 1103.

Next, a decryption apparatus of the stream cipher of the second embodiment is explained.

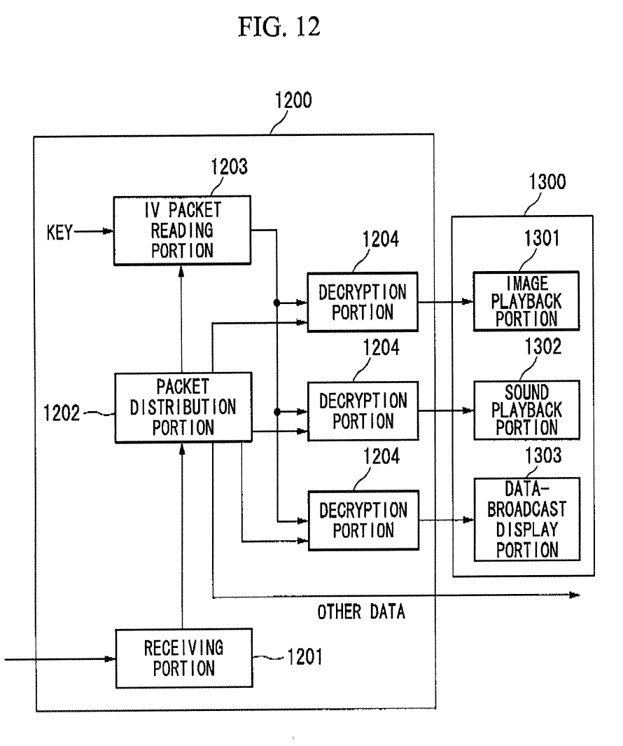

FIG. 12 is a block diagram showing a constitution of a decryption apparatus 1200 of the stream cipher of the second embodiment of the present invention.

In FIG. 12, a receiving portion 1201 receives the TS packet transmitted from the encryption apparatus 1100. The receiving apparatus 1201 conducts an error detection operation and an error correction operation with regard to the received TS packet. In such operations, the IV packet is discarded if an error is detected by the CRC check.

A packet distribution portion 1202 determines a destination of each of the TS packets output from the receiving portion 1201 based on a value of the PID field included in the header. In this operation, the IV packet (value of PID field is “0x889 (hexadecimal)”) is output to an IV packet reading portion 1203. In addition, the encrypted TS packet (value of transport_scrambling_control field is “01”, “10” or “11”) is output to a decryption portion 1204 corresponding to a value of the PID field. On the other hand, the rest of the TS packets that are not encrypted are output from the decryption apparatus without making any changes.

The IV packet reading portion 1203 reads the IV and both the key ID “Current” (id_current) and “Next” (id_next) from the IV packet. A key applied to a stream cipher operation is prepared based on the read key ID “Current” (id_current) and “Next” (id_next). After this, the prepared key and the IV are output to the decryption portion 1204. It should be noted that if the multiple IV (iv[n]) are included in the IV packet each of iv[n] is output to the decryption portion 1204 which has the corresponding stream decipher operation [n].

The decryption portion 1204 decrypts the stream cipher of the encrypted TS packet received from the packet distribution portion 1202.

In this decryption operation of the stream cipher, after receiving the IV and the keys from the IV packet reading portion 1203, the decryption portion 1204 conducts an initializing operation of the stream cipher algorithm by using the received IV. In a following step, after finishing the initializing operation, an decryption operation of the stream cipher is started by using the keys received from the IV packet reading portion 1203. In other words, the initializing operation of the stream cipher is conducted based on a position of the IV packet of the received sequence of the TS packets, and the decryption operation of the stream cipher is conducted with regard to the encrypted TS packets following the IV packet.

The decryption portion 1204 outputs the decrypted TS packet to a playback device 1300.

The playback device 1300 plays back the decrypted TS packet. In an example shown in FIG. 12, the playback device 1300 includes: an image playback portion 1301; a sound playback portion 1302; and a data-broadcast display portion 1303. With regard to each of the image playback portion 1301, the sound playback portion 1302 and the data-broadcast display portion 1303, the decryption apparatus 1200 provides the corresponding decryption portion 1204. Each of the image playback portion 1301, the sound playback portion 1302 and the data-broadcast display portion 1303 plays back the TS packets output from the corresponding decryption portion 1204. It should be noted that a constitution of the playback device 1300 is an example, and it is possible to have appropriate changes on, for example, types of medium.

In accordance with the above-described second embodiment, by using the IV packet, it is possible to achieve a synchronized status between the stream cipher algorithm of the encryption operation and the stream cipher algorithm of the decryption operation. Hence, even if a status between the stream cipher algorithm of the encryption operation and the stream cipher algorithm of the decryption operation is temporally unsynchronized because, for example, the encrypted TS packet is lost due to transmission errors and the like, it is possible to recover a normal decryption operation by achieving a synchronized status between the stream cipher algorithm of the encryption operation and the stream cipher algorithm of the decryption operation when the following IV packet is received. Therefore, in the stream cipher, it is possible to strengthen the tolerance against loss of the transmission data due to transmission errors and the like.

### Third Embodiment

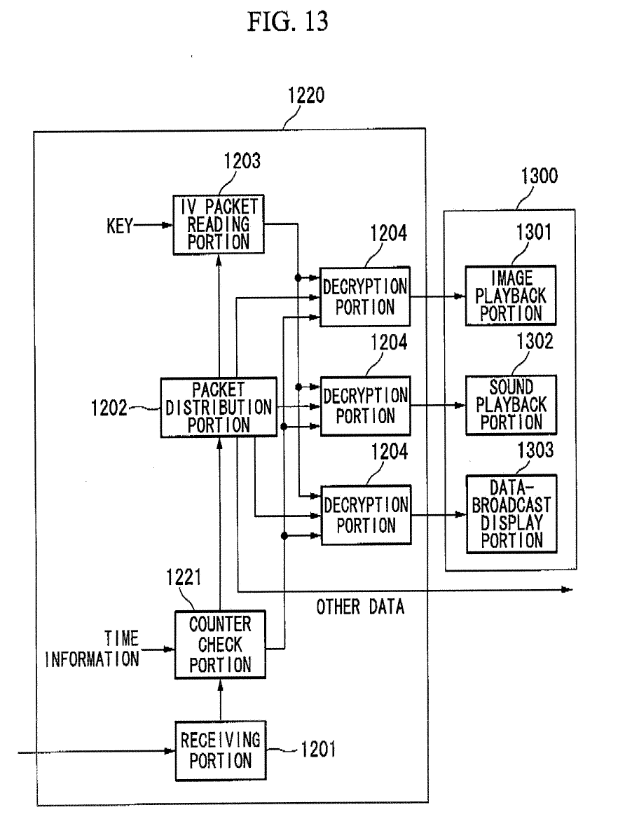

FIG. 13 is a block diagram showing a constitution of a decryption apparatus 1220 of the stream cipher of the third embodiment of the present invention. In FIG. 13, the same numerals are applied to portions that are corresponding portions of FIG. 12, and with regard to such portions, the explanation is omitted. In addition, the encryption apparatus is the same as the second embodiment, hence, the explanation is omitted.

In the third embodiment, as shown in FIG. 13, a counter check portion 1221 is provided. The counter check portion 1221 is a different portion from the decryption apparatus 1200 shown in FIG. 12. The counter check portion 1221 counts a number of lost TS packets which are encrypted.

The continuity_counter (continuity index) is inserted into the header of the TS packet. By detecting the continuity_counter, it is possible to count the number of the lost TS packets. The counter check portion 1221 sends a command to the decryption portion 1204 to conduct an idle operation in response to the number of the lost packets. With regard to each of the decryption portions 1204, the counter check portion 1221 sends both a number of the lost packets and the command to conduct the idle operation of decryption.

The decryption portion 1204 conducts the idle operation of decryption of the stream cipher based on the command to conduct the idle operation of decryption. In this idle operation, the decryption operation is repeated for a time as much as a number of the lost packets even though there is no encrypted data to be decrypted.

By conducting such an operation, a state of the stream cipher algorithm is transited as much as the number of the lost TS packets that have been encrypted. As a result even if the encrypted TS packet is lost, it is possible to avoid a status between the stream cipher algorithm of the encryption operation and the stream cipher algorithm of the decryption operation from being unsynchronized, and it is possible to maintain a synchronized status between the stream cipher algorithm of the encryption operation and the stream cipher algorithm of the decryption operation. Therefore, in the stream ciphers it is possible to strengthen the tolerance against loss of the transmission data due to transmission errors and the like.

It should be noted that if the number of the lost packets is larger than a range that can be counted by a counting function, the counter check portion 1221 does not transmit the command to conduct the idle operation. This is because if the number of the lost packets is larger than a range that can be counted, it is impossible to accurately conduct the idle operation of decryption. Based on time information, for example, if the lost packets continue for a time longer than a predetermined time interval, the counter check portion 1221 determines that the number of the lost packets is lager than a range that can be counted by the counting function.

It should be noted that in the same manner as the second embodiment, if the lost packets continue for a time longer than a predetermined time interval, by using the IV packet, it is possible to achieve a synchronized status between the stream cipher algorithm of the encryption operation and the stream cipher algorithm of the decryption operation.

### Fourth Embodiment

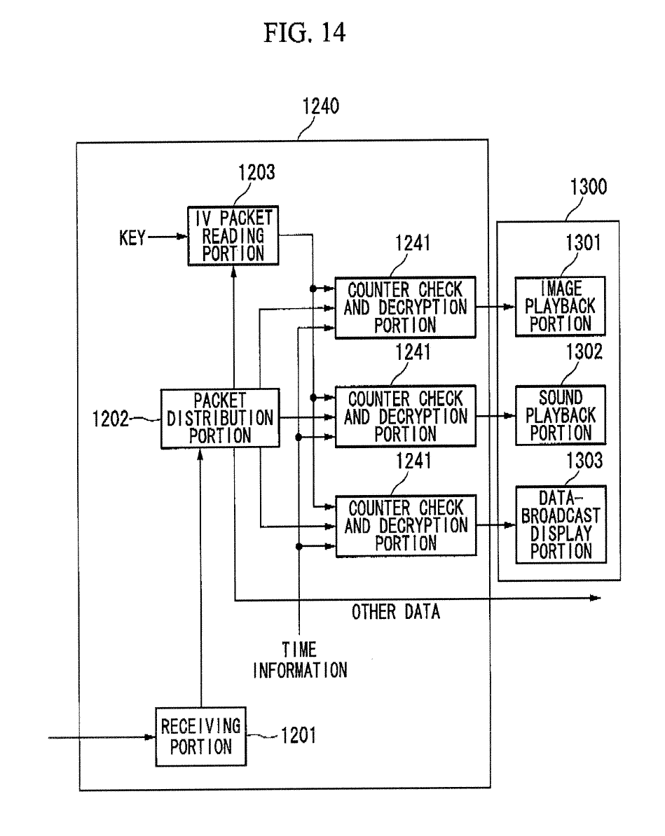

FIG. 14 is a block diagram showing a constitution of a decryption apparatus 1240 of the stream cipher of a fourth embodiment of the present invention. In FIG. 14, the same numerals are applied to portions that are corresponding portions of FIG. 12, and with regard to such portions, the explanation is omitted. In addition, the encryption apparatus is the same as the second embodiment, hence, the explanation is omitted.

In the fourth embodiment, as shown in FIG. 14, instead of the decryption portion 1204, a counter check and decryption portion 1241 is provided. Only the counter check and decryption portion 1241 is a different portion from the decryption apparatus 1200 shown in FIG. 12. Difference from the third embodiment is that a function of the counter check portion 1221 is provided at each of the decryption portions.

The counter check and decryption portion 1241 counts a number of the encrypted and lost TS packets and conducts the idle operation of decryption based on the number of the counted lost packets. In his idle operation, the decryption operation is repeated for a time as much as a number of the lost packets even though there is no encrypted data to be decrypted. In addition, if the number of the lost packets is larger than a range that can be counted by a counting function, the command to conduct the idle operation is not transmitted. Based on time information, for example, if the lost packets continue for a time longer than a predetermined time interval, it is possible to determine that the number of the lost packets is larger than a range that can be counted by the counting function.

Therefore, as described in the third embodiment, even if the encrypted TS packet is lost, it is possible to avoid a status between the stream cipher algorithm of the encryption operation and the stream cipher algorithm of the decryption operation from being unsynchronized, and it is possible to maintain a synchronized status between the stream cipher algorithm of the encryption operation and the stream cipher algorithm of the decryption operation. Therefore, in the stream cipher, it is possible to strengthen the tolerance against loss of the transmission data due to transmission errors and the like.

It should be noted that in the same manner as the second embodiment, if the lost packets continue for a time longer than a predetermined time interval, by using the IV packet, it is possible to achieve a synchronized status between the stream cipher algorithm of the encryption operation and the stream cipher algorithm of the decryption operation.

### Fifth Embodiment

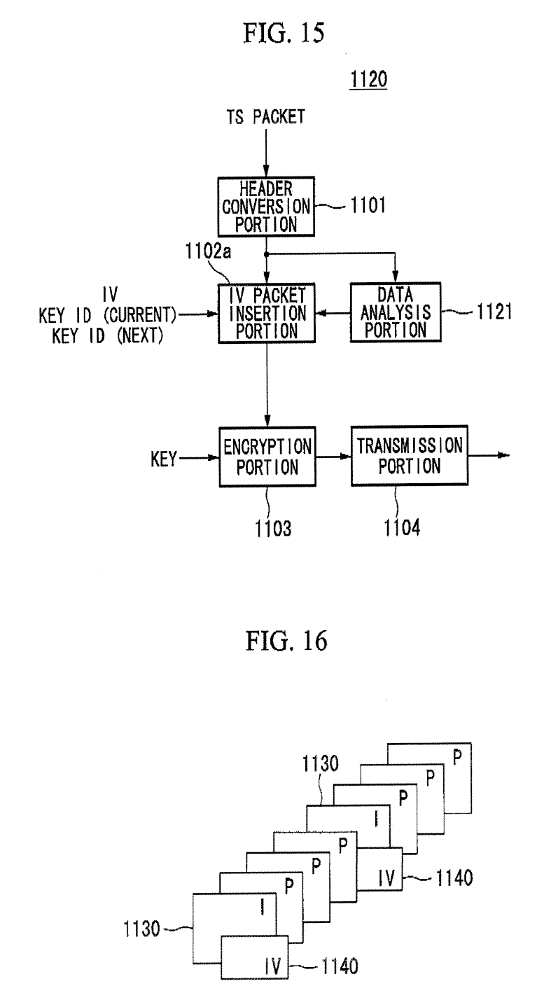

FIG. 15 is a block diagram showing a constitution of an encryption apparatus 1120 of the stream cipher of a fifth embodiment of the present invention. In FIG. 15, the same numerals are applied to portions that are corresponding portions of FIG. 10, and with regard to such portions, the explanation is omitted. In addition, regarding the decryption apparatus, it is possible to use any one of the above-described decryption apparatuses, and the explanation is omitted.

In the fifth embodiment, as shown in FIG. 15, a data analysis portion 1121 is provided. A portion regarding the data analysis portion 1121 is the only difference from the encryption portion 1100 of FIG. 10. The data analysis portion 1121 analyses the stream content data stored in the TS packets. The data analysis portion 1121 determines a unit of the stream content data to be processed based on the analysis results. The data analysis portion 1121 transmits a command to the IV packet insertion portion 1102a to insert the IV packet with regard to each unit of the stream content data. The IV packet insertion portion 1102a inserts the IV packet at the time specified by the data analysis portion 1121. In accordance with such an operation, the IV packet is inserted into each of the units of the stream content data.

Hereinafter, with regard to each of the types of the stream contents, the IV packet insertion operation of this embodiment is explained. It should be noted that examples of the stream contents are the video contents, the sound contents and the data-broadcast contents.

### (Video Contents)

Regarding the video contents, the IV packet is inserted into a position just before the TS packet which stores a reference video frame. For example, in an video encoding method such as MPEG-1, 2 or 4, three types of pictures are generated that are I-picture (Intra-Picture), P-picture (Predictive-Picture) and B-picture (Bi-directional Predictive Picture). Among these pictures, I-picture is the reference video frame that is referred when the video is decoded. Therefore, in order to accurately decode the video, it is necessary to accurately decode I-picture. As shown in FIG. 16, the IV packet 1140 is inserted just before the TS packet which includes an I-picture 1130. Hence, encryption and decryption operations of the I-picture is started in a state in which the stream cipher algorithm is initialized, and in addition, the decryption operation of the encrypted data of the I-picture is reliably conducted. Hence, it is possible to improve a stable playback operation of the video contents.

It should be noted that with regard to an encoding method such as H.264, in addition to above-described three types of the pictures, an IDR (Instantaneous Decoder Refresh) picture is generated which is a reference frame. In a case of applying such an encoding method, it is possible to insert the IV packet just before the IDR-packet.

### (Sound Contents)

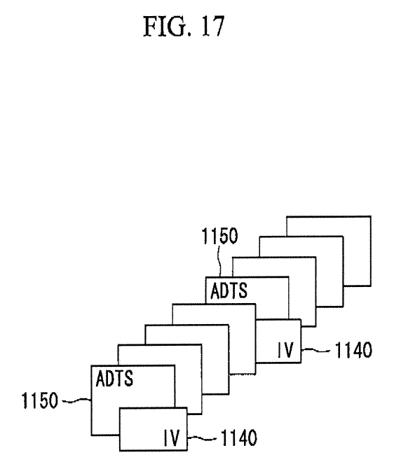

Regarding the sound contents, the IV packet is inserted into a position just before the TS packet which stores a sound frame. For example, with regard to a digital broadcasting, the sound encoded data is transported in a frame which provides a header called ADTS (Audio Data Transport Stream). From the ADTS header, the sound frame starts, and hence he ADTS header is a reference when the sound encoded data is decoded. Therefore, as shown in FIG. 17, the IV packet 1140 is inserted just before the TS packet which includes an ADTS header 1150. Hence, the stream cipher algorithm is initialized just before the sound frame, encryption and decryption operations of the sound frame is started in a state in which the stream cipher algorithm is initialized, and in addition, the decryption operation of the encrypted data of the sound frame is reliably conducted. Hence, it is possible to improve a stable playback operation of the sound contents.

### (Data-Broadcast Contents)

In a case of the data-broadcast contents, the IV packet is inserted for each of units of data that is repeatedly broadcasted (data carrousel). Hence, the stream cipher algorithm is initialized just before the data carrousel, encryption and decryption operations of the data carousel is started in a state in which the stream cipher algorithm is initialized, and in addition, the decryption operation of the encrypted data of the data carousel is reliably conducted. Hence, it is possible to improve a stable playback operation of the data-broadcast contents.

Thereinbefore, in reference to the drawings, embodiments of the present invention are explained in detail, but a concrete constitution is not limited to the above-described embodiments, and it should be understood that it is possible to apply modifications of designs if it is not out of the concept of the present invention.

For example, it is possible to apply the above-described embodiments to a digital broadcast system for mobile terminals. In such a case, even if a status of the stream cipher algorithm is temporally unsynchronized between a broadcast station and a mobile terminal because, for example, the TS packet including the data encrypted by the stream cipher is lost due to transmission errors of the broadcast data of the digital broadcasting, it is possible to recover a receiving status in the digital broadcast by achieving a synchronized status of the stream cipher algorithm between the broadcast station and the mobile terminal by using the following IV packet. Therefore, it is possible to improve high quality of the digital broadcast for mobile terminals.

It should be noted that it is possible to apply the present invention to various types of broadcast systems and communication systems.

### INDUSTRIAL APPLICABILITY

In accordance with the present invention, it is possible to provide various service types to the users in a case of supplying the contents constituted from multiple resources received via broadcast. In addition, in accordance with the present invention, in the stream cipher, it is possible to strengthen the tolerance against loss of the transmission data due to transmission errors and the like.

1. An encryption apparatus used for providing contents constituted from a plurality of resources via broadcast, comprising:
an encryption unit encrypting each of resources-to-be-encrypted by applying a corresponding encryption key;
a packet generation unit generating packets that store encrypted data or non-encrypted data of the resources; and
a transmission unit transmitting the packets.

2. A license issuing apparatus providing, via communication network, a license used for decrypting a plurality of resources which constitute contents transmitted via broadcast and which are encrypted by using a corresponding encryption key, comprising:
a memory unit storing the license; and
a license transmission unit transmitting the license stored in the memory unit, wherein
the license comprises a combination of a license identifier and a decryption key,
the license identifier indicates a broadcast range in which the license is effective, and
the decryption key is provided in correspondence with each of resources-to-b-encrypted.

3. A decryption apparatus used for providing contents constituted from a plurality of resources via broadcast while including encrypted resources by using corresponding encryption key if the resources are to be encrypted, comprising:
a broadcast receiving unit receiving packets via broadcast;
a packet distribution unit distributing the received packets including encrypted data for each resources-to-be-encrypted;
a license receiving unit receiving a license via communication network; and
a decryption unit decrypting the encrypted data included in the packets distributed for each resources-to-be-encrypted, by using a corresponding decryption key included in the received license.

4. A decryption apparatus according to claim 3, further comprising a license maintaining unit which stores the license.

5. A decryption apparatus according to claim 3, further comprising a decryption control unit which, based on the license identifier, controls the decryption of broadcast for the range in which the license is effective.

6. A decryption apparatus according to claim 3, further comprising a storage unit which stores the contents received via broadcast.

7. A decryption apparatus according to claim 3, further comprising a licensing unit obtaining via communication network, a license that is effective to the range of the broadcast which is currently being received.

8 A decryption apparatus according to claim 3, further comprising:
a display unit indicates contents on a screen that are currently being received or going to be received via broadcast;
a designation unit accepting a designation of the contents which are indicated on the screen; and
a licensing unit obtaining a license corresponding to the designated contents via the designation unit.

9. A decryption apparatus according to claim 6, further comprising:
a display unit indicates contents on a screen that are currently received or going to be received via broadcast or that are stored in the storage unit;
a designation unit accepting a designation of the contents which are indicated on the screen; and
a licensing unit obtaining a license corresponding to the designated contents via the designation unit.

10. A decryption apparatus according to claim 6, wherein the display unit indicates on the screen whether or not there is a license corresponding to the designated contents which are indicated on the screen.

11. An encryption apparatus comprising:
an initialization packet generation unit generating an initialization packet which stores an initial value used in an initializing operation of a stream cipher algorithm and which is generated in an interval between initializing operations of the stream cipher algorithm;
an encrypting unit conducting a stream cipher operation after the initialization operation of the stream cipher algorithm by using the initial value stored in the initialization packet;
an encrypted packet generation unit generating an encrypted packet including data on which the stream cipher operation is conducted; and
a transmission unit transmitting both the encrypted packet and the initialization packet.

12. An encryption apparatus according to claim 11, wherein the initialization packet generation unit applies an initialization interval corresponding to types of media of data which is going to be encrypted.

13. An encryption apparatus according to claim 11, wherein the encryption unit is plural, and the initial value of each of a plurality of the encryption units is stored in the initialization packet by the initialization packet generation unit.

14. An encryption apparatus according to claim 11, wherein the initialization packet and the encrypted packet are transport packets and are different types of packets.

15. A decryption apparatus comprising:
a receiving unit receiving an initialization packet and an encrypted packet; and
a decrypting unit, after conducting an initialization operation of stream decipher algorithm by using a given initial value stored in the initialization packet, conducting a stream decipher operation in order to obtain data on which a stream cipher operation is conducted from the encrypted packet.

16. A decryption apparatus according to claim 15, wherein
the decryption unit is plural, and
each of the decryption units uses the given initial value and decrypts given data on which a stream cipher operation has been conducted.

17. A decryption apparatus according to claim 15, her comprising a counting unit which counts the encrypted packets that are lost, wherein
the decryption portion conducts an idle operation of the decipher operation for a time as much as a number of the lost encrypted packets.

18. A decryption apparatus according to claim 16, further comprising a plurality of counting units in correspondence with the decryption units counting the encrypted packets that are lost, wherein
the decryption portion conducts an idle operation of the decipher operation for a time as much as a number of the lost encrypted packets.

19. A decryption apparatus according to claim 17, wherein the decryption unit avoids conducting the idle operation if a number of the lost packets exceeds a countable range.

20. A decryption apparatus according to claim 15, wherein the initialization packet and the encrypted packet are transport packets and are different types of packets.

21. An encryption apparatus comprising:
an initialization packet insertion unit inserting an initialization packet, which stores an initial value used in an initialization operation of a stream cipher algorithm, into a sequence of packets that store stream content data at a position of each of its of the stream content data;
an encrypting unit conducting a stream cipher operation on the stream content data after an initialization operation of a stream cipher algorithm by using the initial value stored in the initialization packet; and
a transmission unit transmitting both an encrypted packet storing the encrypted stream content data and the initialization packet.

22. An encryption apparatus according to claim 21, wherein the initialization packet insertion unit inserts the initialization packet at a position just before a packet which stores a reference video frame.

23. An encryption apparatus according to claim 22, wherein the reference video frame is an I-picture or an IDR-picture.

24. An encryption apparatus according to claim 21, wherein the initialization packet insertion unit inserts the initialization packet at a position just before a packet which stores a sound frame.

25. An encryption apparatus according to claim 24, wherein the initialization packet insertion unit inserts the initialization packet at a position just before a packet which stores an ADTS header.

26. An encryption apparatus according to claim 21, wherein the initialization packet insertion unit inserts the initialization packet into a sequence of packets, which store data-broadcast content data, for every unit of data that are repeatedly broadcasted.

27. A content data generation method comprising the steps of:
conducting an initialization operation of a stream cipher algorithm by using an initial value stored in an initialization packet;
conducting a stream cipher operation of stream content data; and
inserting the initialization packet, which stores an initial value used the an initialization operation of the stream cipher algorithm, into a sequence of packets that store the stream content data for every units of the stream content data.

28. A content data generation method according to claim 27, wherein the initialization packet is inserted at a position just before a packet which stores a reference video frame.

29. A content data generation method according to claim 28, wherein the reference video frame is an I-picture or an IDR-picture.

30. A content data generation method according to claim 27, wherein the initialization packet is inserted at a position just before a packet which stores a sound frame.

31. A content data generation method according to claim 30, wherein the initialization packet is inserted at a position just before a packet which stores an ADTS header.

32. A content data generation method according to claim 30, wherein the initialization packet is inserted into a sequence of packets, which store data-broadcast content data, for every unit of data that are repeatedly broadcasted.

33. An encryption apparatus according to claim 11, wherein
the encryption unit, regarding contents constituted from a plurality of resources, encrypts each of the resources-to-be-encrypted by applying a corresponding encryption key,
the encrypted packet generation unit generates packets that store encrypted data or non-encrypted data of the resources, and
the transmission unit transmits the packet generated by the encrypted packet generation unit.

34. An encryption apparatus according to claim 1, further comprising an initialization packet generation unit generating an initialization packet which stores an initial value used in an initializing operation of a stream cipher algorithm and which is generated in an interval between initializing operations of the stream cipher algorithm, wherein
the encrypting unit conducts a stream cipher operation after the initialization operation of the stream cipher algorithm by using the initial value stored in the initialization packet.

35. An encryption apparatus according to claim 33 or 34, wherein the initialization packet generation unit applies an initialization interval corresponding to types of media of data which is going to be encrypted.

36. An encryption apparatus according to claim 33 or 34, wherein the encryption unit is plural, and the initial value of each of a plurality of the encoding units is stored in the initialization packet by the initialization packet generation unit.

37. A decryption apparatus according to claim 33 or 34, wherein the initialization packet and the encrypted packet are transport packets and are different types of packets.

38. A broadcast system providing contents via broadcast, comprising:
an encryption unit, encrypting each of the plurality of contents constituted from a plurality of resources by applying a corresponding encryption key and generating and transmitting packets that store encrypted data or non-encrypted data of the resources;
a licensing unit transmitting via communication network, a license that is used for decrypting the encrypted data; and
a decryption unit, after receiving the packets including encrypted data for each resource-to-be-encrypted, decrypting the encrypted data by using the license received via communication network, wherein
the license comprises a combination of a license identifier and a decryption key,
the license identifier indicates a broadcast range in which the license is effective, the decryption key is provided in correspondence with each of resources-to-be-encrypted,
the decryption unit, by using the received corresponding decryption key included in the license, decrypts the encrypted data of the packet for each resource-to-be-encrypted.
